(19) United States
(12) Patent Application Publication
(10) Pub. No.: US 2009/0303008 A1
(43) Pub. Date: Dec. 10, 2009

(54) RADIO FREQUENCY IDENTIFICATION TAG HAVING TESTING CIRCUIT

(76) Inventor: Hee Bok KANG, Chungcheongbuk-do (KR)

Correspondence Address: LADAS & PARRY LLP, 224 SOUTH MICHIGAN AVENUE, SUITE 1600, CHICAGO, IL, 60604, US

(21) Appl. No.: 12/345,723

(22) Filed: Dec. 30, 2008

(30) Foreign Application Priority Data
Jun. 9, 2008 (KR) 10-2008-0053723

(51) Int. Cl. H04Q 5/22

(52) U.S. Cl. 340/10.1

(57) ABSTRACT

An RFID tag with a testing circuit includes an analog block having a test unit configured to output a command signal in response to an operation command signal and receiving an externally applied test input signal, and to output a test output signal corresponding to a response signal to outside of the RFID tag. In the RFID tag, a digital block is configured to output an operation control signal and to output the response signal to the analog block. A memory block is configured to receive the operation control signal in order to generate an internal control signal for controlling internal operation, and to read/write data in a cell array including nonvolatile ferroelectric capacitors in response to the internal control signal.

### CROSS-REFERENCE TO RELATED APPLICATION

This application claims the benefit of priority to Korean Patent Application No. 10-2008-0053723, filed on 9 Jun. 2008, the entire contents of which are incorporated herein by reference.

### BACKGROUND OF THE INVENTION

The present invention relates to a radio frequency identification (RFID) tags.

RFID devices have been recently developed for use in a physical distribution managing system, a user identification system, an electronic money system, and a traffic system.

In the past, a physical distribution management system would use a delivery slip to keep track of cargo distribution and inventory control. Instead of a deliver slip, physical distribution managing system performs are being to keep track of cargo distribution and inventory control using an integrated circuit (IC) tag in which data can be recorded instead of a delivery slip. For example, the user identification system can manage exit and entry control using an IC card having personal information recorded thereon.

Meanwhile, a RFID tag utilizes a memory to store this personal information.

Ferroelectric Random Access Memory (FeRAM) is a memory device in which data is conserved even when power supply to the memory is terminated. A FeRAM has been considered to have a data processing speed similar to that of Dynamic Random Access Memory (DRAM).

A FeRAM device may have a structure similar to that of a DRAM device, and includes capacitors made of a ferroelectric substance and having a high residual polarization allowing for data retention even when en electric field is removed.

FIG. 1 is a diagram showing a conventional RFID tag. The conventional RFID tag has an antenna 10, an analog block 20, a digital block 30, and a memory 40.

The antenna 10 transmits and receives a radio frequency signal between an external reader or writer and an RFID tag.

The analog block 20 has a voltage multiplier 21, a voltage limiter 22, a modulator 23, a demodulator 24, a voltage doubler 25, a power on reset unit 26, and a clock generating unit 27.

The voltage multiplier 21 generates a power voltage VDD for the RFID tag using the radio frequency signal received from the antenna 10. The voltage limiter 22 limits the voltage size of the radio frequency signal applied from the antenna 10.

The modulator 23 modulates a response signal RP received from the digital block 30 and transmits the response signal RP to the antenna 10. The demodulator 24 detects an operation command signal of the radio frequency signal received from the antenna 10 using the power voltage VDD, and outputs a command signal CMD to the digital block 30.

The voltage doubler 25 boosts the power voltage VDD received from the voltage multiplier 21, and supplies a voltage VDD2 (i.e., the boosted power voltage VDD) having a swing width that is twice that of the power voltage VDD to the memory 40.

The power on reset unit 26 senses the size of the power voltage VDD applied from the voltage multiplier 21, and outputs a power on reset signal POR for controlling a reset operation to the digital block 30.

The clock generating unit 27 generates a clock signal CLK using the power voltage VDD.

The digital block 30 receives the power voltage VDD, the power on reset signal POR, the clock signal CLK and the command signal CMD from the analog block 20. The digital block 30 outputs the response signal RP to the analog block 20 in response to the received signals. The digital block 30 outputs an address ADD, data I/O, a control signal CTR and the clock signal CLK to the memory 40.

The memory 40 includes a plurality of memory cells. Each memory cell may include a nonvolatile ferroelectric capacitor.

### SUMMARY OF THE INVENTION

Various embodiments of the present invention are directed at providing a RFID tag.

According to an embodiment of the present invention, a RFID tag comprises: an analog block including a test unit configured to output a command signal in response to an operation command signal and an externally applied test input signal, and to output a test output signal externally corresponding to a response signal; a digital block configured to output an operation control signal, and to output the response signal to the analog block; and a memory block configured to receive the operation control signal so as to generate an internal control signal for controlling an internal operation, and to read/write data in a cell array including a nonvolatile ferroelectric capacitor in response to the internal control signal.

According to another embodiment of the present invention, a RFID tag includes an analog block, a digital block and a memory block for reading/writing data in a cell array that includes nonvolatile ferroelectric capacitors. The analog block includes a test unit configured to output a command signal in response to a test input signal applied externally in a test operation mode, and to output a test output signal externally corresponding to a response signal applied from the digital block.

### BRIEF DESCRIPTION OF THE DRAWINGS

FIG. 1 is a diagram showing a conventional RFID tag.

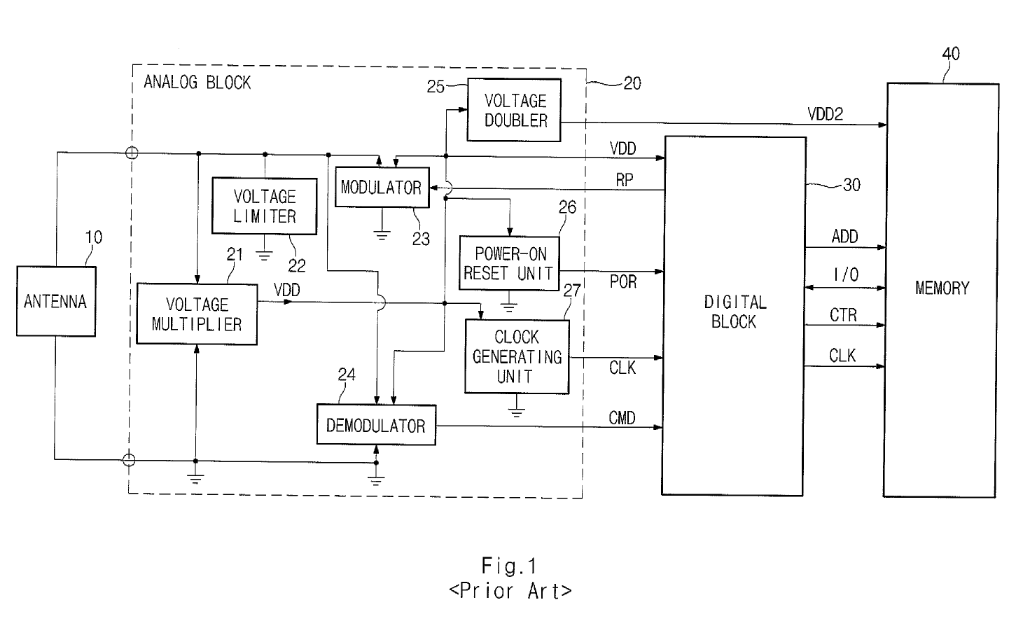

FIG. 2 is a diagram showing an RFID tag according to an embodiment of the present invention.

FIG. 3 is a circuit diagram showing an embodiment of the test input buffer of the RFID tag shown in FIG. 2.

FIG. 4 is a waveform diagram shown for illustrating a normal mode operation of the test input buffer shown in FIG. 3.

FIG. 5 is a waveform diagram shown for illustrating a test mode operation of the test input buffer shown in FIG. 3.

FIG. 6 is a circuit diagram showing an embodiment of the test output driving unit of the RFID tag shown in FIG. 2.

FIG. 7 is a waveform diagram shown for illustrating a test mode operation of the test output driving unit shown in FIG. 6.

### DESCRIPTION OF SPECIFIC EMBODIMENTS

The present invention will now be described in detail with reference to the accompanying drawings.

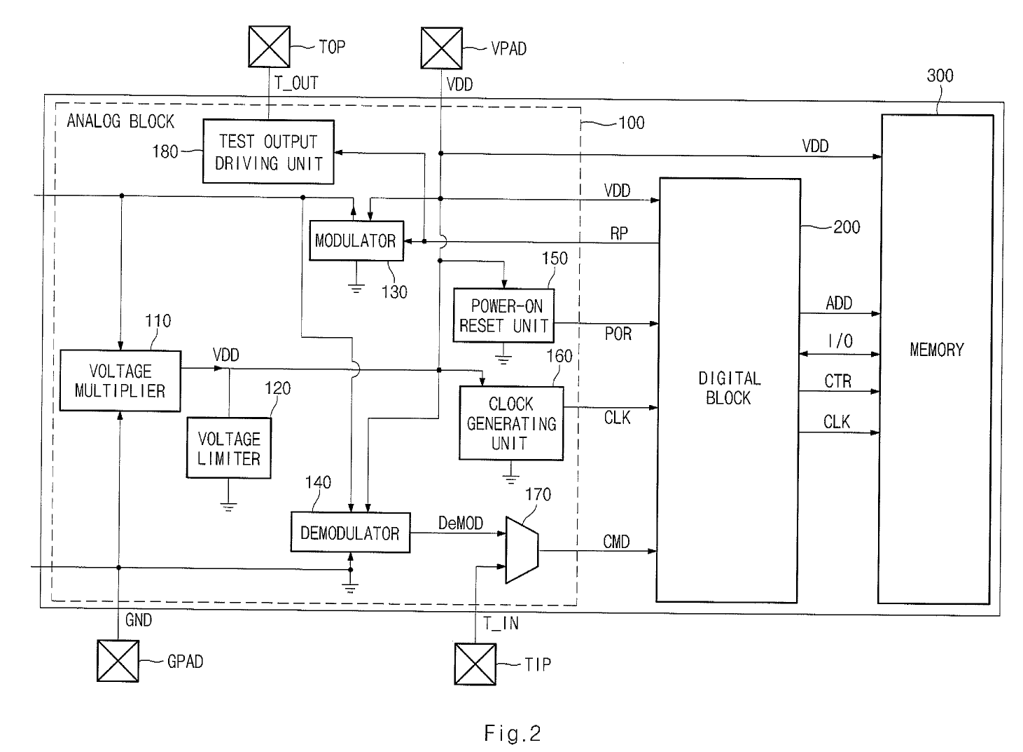

FIG. 2 is a diagram showing an RFID tag according to an embodiment of the present invention. A conventional RFID tag receives a radio frequency signal RF from the antenna 10. However, the RFID tag of FIG. 2 applies a measuring signal directly through a test pad at a wafer level to test the performance of the RFID tag.

The RFID tag of FIG. 2 comprises an analog block 100, a digital block 200 and a memory 300. Additionally, the RFID tag of FIG. 2 comprises a power voltage VDD applying pad VPAD, a test output pad TOP, a ground voltage GND applying pad GPAD and a test input pad TIP outside the RFID tag. As a result, the RFID tag according to an embodiment of the present invention can test the performance of the RFID tag without the use of antennas.

The analog block 100 comprises a voltage multiplier 110, a voltage limiter 120, a modulator 130, a demodulator 140, a power on reset unit 150, a clock generating unit 160 and a test unit. The test unit comprises a test input buffer 170 and a test output driving unit 180.

The voltage multiplier 110 of the analog block 100 generates a driving voltage depending on a power voltage VDD applied from the power voltage VDD applying pad VPAD when the device is in test mode operation. The voltage limiter 120 limits the size of the power voltage VDD and outputs the power voltage VDD to the modulator 130, the demodulator 140, the power on reset unit 150 and the clock generating unit 160.

The modulator 130 modulates a response signal RP applied from the digital block 200. The demodulator 140 detects an operation command signal according to output voltages from the voltage multiplier 110, the voltage limiter 120 and the power voltage VDD applying pad VPAD.

The power on reset unit 150 senses the output voltage received from the voltage multiplier 110 and a voltage received from the power voltage VDD applying pad VPAD, and outputs a power on reset signal POR for controlling a reset operation to the digital block 200.

The clock generating unit 160 supplies a clock CLK for controlling the operation of the digital block 200 to the digital block 200 depending on the output voltage received from the voltage multiplier 110 and the output voltage received from the power voltage VDD applying pad VPAD when the device is in test mode operation.

The test input buffer 170 outputs a command signal CMD to the digital block 200 in response to an operation command signal DeMOD received from the demodulator 140 and a test input signal received from the test input pad TIP.

In more detail, the test input buffer 170 outputs the command signal CMD to the digital block 200 in response to (and corresponding to) the operation command signal DeMOD applied from the demodulator 140 when the RFID tag is in normal operation mode. Conversely, the test input buffer 170 supplies the command signal CMD to the digital block 200 in response to (and corresponding to) a test input signal T_IN applied from the test input pad TIP when the RFID tag is in test operation mode.

The test output driving unit 180 outputs a test output signal T_OUT to the test output pad TOP located outside of the RFID tag when the test output driving unit 180 receives the response signal RP from the digital block 200.

When the RFID tag is in test operation mode, the voltage multiplier 110, the voltage limiter 120, the modulator 130, the demodulator 140, the power on reset unit 150 and the clock generating unit 160 are driven by the power voltage VDD received from the power voltage VDD applying pad VPAD and a ground voltage GND received from the ground voltage GND applying pad GPAD.

In more detail, the power voltage VDD and the ground voltage GND are received from outside (i.e. externally) of the RFID tag and are applied to the internal circuit of the RFID tag in order to test the performance of the RFID tag at a wafer state and without having to use antennas.

The digital block 200 receives the power voltage VDD, the power on reset signal POR, the clock CLK and the command signal CMD from the analog block 100. The digital block 200 analyzes the received command signal CMD to generate a control signal and processing signals, and outputs the response signal RP corresponding to the received signals. The digital block 200 outputs the address ADD, input/output data I/O, a control signal CTR and the clock signal CLK to a FeRAM 300.

A memory 400 includes a plurality of memory cells. Each of memory cells may include a nonvolatile ferroelectric capacitor.

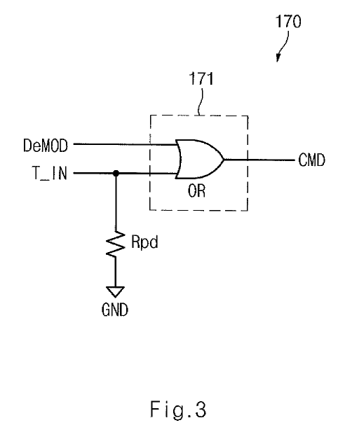

FIG. 3 is a circuit diagram showing an embodiment of the test input buffer of the RFID tag shown in FIG. 2.

The test input buffer 170 comprises a test input unit 171 and a resistor Rpd. The test input unit 171 activates the command signal CMD when one of the operation command signal received from the demodulator 140 and the test input signal T_IN received from the test input pad TIP is activated. The activated command signal CMD is outputted to the digital block 200.

The test input unit 171 may include an OR gate configured to perform an OR logical operation on the operation command signal DeMOD (from the demodulator 140) and the test input signal T_IN (from the test input pat TIP). The resistor Rpd is connected between the input terminal of the test input unit that receives the test input signal T_IN and a ground GND terminal.

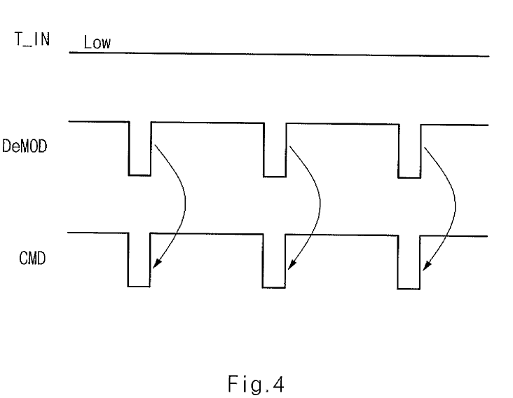

FIG. 4 is a waveform diagram shown for illustrating the operation of the test input buffer of FIG. 3 when the RFID tag is in normal mode. Referring to FIG. 4, the normal mode operation of the test input buffer 170 is as follows.

In the normal operation mode, the test input signal T_IN received from the test input pad TIP maintains a low level. That is, the test input pad TIP is in a floating state during normal operation mode, and the test input signal T_IN is at the low level in the resistor Rpd, which is a pull-down resistor.

The test input buffer 170 activates the command signal CMD in response to the operation command signal DeMOD received from the demodulator 140, and then outputs the activated command signal CMD to the digital block 200.

The operation command signal DeMOD has a pulse waveform of a low level (i.e., a pulse of the pulse waveform has a low level). The test input buffer 170 is synchronized with the operation command signal DeMOD to output the command signal CMD having a pulse waveform with the same low level as that of the operation command signal DeMOD.

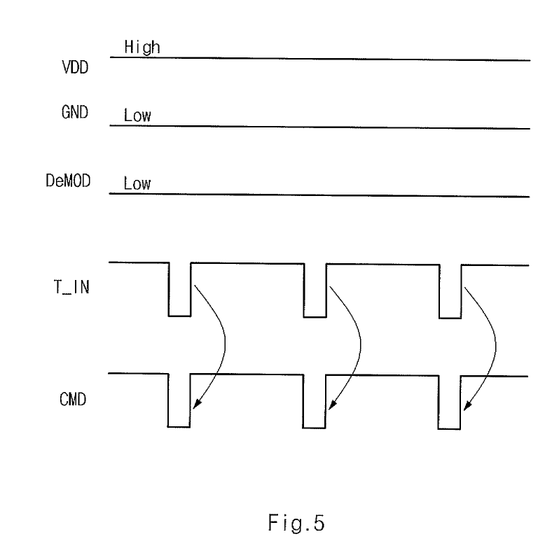

FIG. 5 is a waveform diagram shown for illustrating the operation of the test input buffer of FIG. 3 when the RFID tag is in test mode. Referring to FIG. 5, the test mode operation of the test input buffer 170 is as follows.

In the test operation mode, the power voltage VDD received from the power voltage VDD applying pad VPAD maintains a high level, and the ground voltage GND received from the ground voltage GND applying pad GPAD maintains a low level.

The operation command signal DeMOD received from the demodulator 140 maintains a low level. Since the RFID tag of the present invention does not need the use of antennas when in test mode operation, the RFID tag does not utilize a radio frequency signal when the RFID tag is in the test operation mode.

When the RFID tag is in the test operation mode, the command signal CMD is activated in response to the test input signal T_IN received from the test input pad TIP, and the activated command signal CMD is outputted to the digital block 200.

That is, in the test operation mode, the test input signal T_IN is activated through the test input pad TIP. When the test input signal T_IN is activated, the driving capacity of the test input signal T_IN is larger than that of the resistor Rpd (which is a pull-down resistor). As a result, a resistance value of the resistor Rpd can be ignored, and the command signal CMD is outputted to the digital block 200 in response to the test input signal T_IN.

The test input signal T_IN has a pulse waveform of a low level. The test input buffer 170 is synchronized with respect to the test input signal T_IN to output a command signal CMD having a pulse waveform of the same low level as that of the test input signal T_IN.

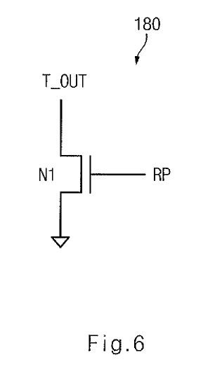

FIG. 6 is a circuit diagram showing an embodiment of the test output driving unit of the RFID tag shown in FIG. 2.

The test output driving unit 180 selectively outputs the test output signal T_OUT to the test output pad TOP in response to the response signal RP received from the digital block 200.

The test output driving unit 180 may include an NMOS transistor N having an open drain structure. The NMOS transistor N1 is connected between an output terminal of the test output signal T_OUT (i.e., the terminal in which the output signal T_OUT is outputted) and the ground terminal. Thus, the drain of the NMOS transistor N1 is connected to the test output pad TOP shown in FIG. 2.

The gate of the NMOS transistor N1 receives the response signal RP. When the response signal RP is activated at a high level, the test output signal T_OUT is outputted at a low level. When the response signal RP is deactivated at a low level, the test output signal T_OUT is outputted at a high level.

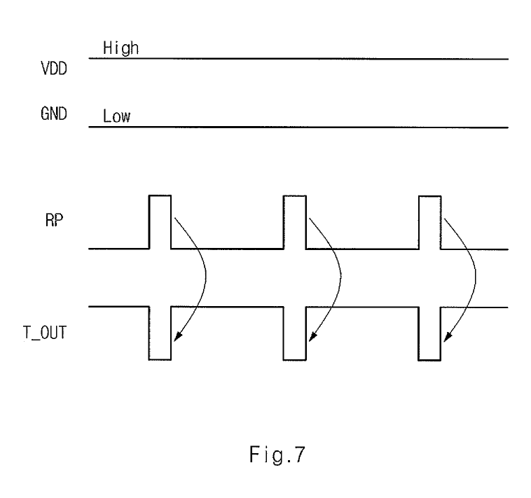

FIG. 7 is a waveform diagram shown for illustrating a the operation of the test output driving unit shown in FIG. 6 when the RFID tag is in a test mode. Referring to FIG. 7, the test mode operation of the test input buffer 170 is as follows.

In the test operation mode, the power voltage VDD received from the power voltage VDD applying pad VPAD maintains a high level, and the ground voltage GND received from the ground voltage GND applying pad GPAD maintains a low level.

When the response signal RP is activated at the high level, the NMOS transistor N1 is turned on, and the test output signal T_OUT is outputted at the low level (as described above, when the response signal RP is activated at a high level, the test output signal T_OUT is outputted at a low level). When the response signal RP is deactivated at the low level, the NMOS transistor N1 is turned off, and the test output signal T_OUT is outputted at the high level.

The response signal RP has a pulse waveform of a high level. The test output driving unit 180 outputs the test output signal T_OUT such that the test output signal T_OUT has a phase that is opposite to that of the response signal RP, as such, the test output signal T_OUT is output to the test output pad TOP in response to the response signal RP. As a result, it is possible to judge 5 whether the RFID tag is operating normally by observing the output waveform of the test output signal T_OUT outputted from the test output pad TOP.

That is, while the power voltage VDD and the ground voltage GND are supplied from outside of the RFID tag to the internal circuit of the RFID tag, it is possible to judge whether the RFID tag is operating normally according to the applied test input signal T_IN and the outputted test output signal T_OUT.

As described above, the present invention directly applies a measuring signal through a test pad at a wafer level in order to facilitate testing of the performance of the RFID tag, thereby reducing test time and test cost.

Although a number of illustrative embodiments consistent with the invention have been described, it should be understood that numerous other modifications and embodiments can be devised by those skilled in the art that will fall within the spirit and scope of the principles of this disclosure. Particularly, numerous variations and modifications are possible in the component parts and/or arrangements which are within the scope of the disclosure, the drawings, and the accompanying claims. In addition to variations and modifications in the component parts and/or arrangements, alternative uses will also be apparent to those skilled in the art.

What is claimed is:

1. A RFID tag comprising:
an analog block comprising a test unit configured to output a command signal according to a test input signal received from outside the RFID tag, and to output a test output signal to outside of the RFID tag, the test output signal corresponding to a response signal;
a digital block configured to output an operation control signal and the response signal according to the command signal received from the analog block; and
a memory block configured to receive the operation control signal from the digital block , wherein the memory block reads/writes data in a cell array

2. The RFID tag according to claim 1, wherein the test unit comprises:
a test input buffer configured to output the command signal to the digital block in response to the test input signal; and
a test output driving unit configured to receive the response signal from the digital block and to drive and output the test output signal corresponding to the response signal.

3. The RFID tag according to claim 1 or 2, wherein the test unit comprises:
a test input pad configured to receive the test input signal; and
a test output pad configured to output the test output signal,
wherein the test input pad receives the test input signal from outside the RFID tag and the test output pad outputs the test output signal to outside of the RFID tag at wafer level.

4. The RFID tag according to claim 2, wherein the test unit further comprises:
a power voltage applying pad configured to supply a power voltage to the analog block, wherein the power voltage apply pad receives the power voltage from outside the RFID tag at wafer level; and
a ground voltage applying pad configured to supply a ground voltage to the analog block, wherein the ground voltage applying pad receives the ground voltage from outside the RFID tag at wafer level.

5. The RFID tag according to claim 2, wherein the test input buffer comprises:
a test input unit configured to output the command signal, wherein the test input unit generates the command signal according to an internally generated operation command signal and the test input signal; and
a pull-down resistor connected between an input terminal of the test input unit receiving the test input signal and a ground terminal.

6. The RFID tag according to claim 5, wherein the test input unit activates and outputs the command signal when either the operation command signal or the test input signal is activated.

7. The RFID tag according to claim 5, wherein the test input unit outputs the command signal such that the command signal corresponds to the operation command signal when in a normal mode, and wherein the test input unit outputs the command signal such that the command signal corresponds to the test input signal when in a test mode.

8. The RFID tag according to claim 5, wherein a power voltage and a ground voltage each received from outside the RFID tag are applied to the analog block when in a test operation mode.

9. The RFID tag according to claim 2, wherein the test output driving unit comprises a MOS transistor having an open drain structure.

10. The RFID tag according to claim 9, wherein the MOS transistor is an NMOS transistor connected between the output of the test output signal and a ground terminal, and the NMOS transistor has a gate receiving the response signal.

11. The RFID tag according to claim 9, wherein a power voltage and a ground voltage each received from outside the RFID tag are applied to the analog block when in a test operation mode.

12. The RFID tag according to claim 1, wherein the cell array includes a plurality of nonvolatile ferroelectric capacitors.

13. A RFID tag comprising:
a memory block;
a digital block; and
an analog block, wherein the analog block comprises a test unit configured to output a command signal to the digital block in response to a test input signal when in a test operation mode, and wherein the test unit is configured to output a test output signal corresponding to a response signal received from the digital block.

14. The RFID tag according to claim 13, wherein the test unit comprises:
a test input buffer configured to output the command signal to the digital block in response to the test input signal; and
a test output driving unit configured to receive the response signal from the digital block and to drive and output the test output signal corresponding to the response signal.

15. The RFID tag according to claim 13 or 14, wherein the test unit comprises:
a test input pad configured to receive the test input signal; and
a test output pad configured to output the test output signal,
wherein the test input pad receives the test input signal from outside the RFID tag and the test output pad outputs the test output signal to outside of the RFID tag at wafer level.

16. The RFID tag according to claim 14, wherein the test unit further comprises:
a power voltage applying pad configured to supply a power voltage to the analog block, wherein the power voltage apply pad receives the power voltage from outside the RFID tag at wafer level; and
a ground voltage applying pad configured to supply a ground voltage to the analog block, wherein the ground voltage applying pad receives the ground voltage from outside the RFID tag at wafer level.

17. The RFID tag according to claim 14, wherein the test input buffer comprises:
a test input unit configured to output the command signal, wherein the test input unit generates the command signal according to an internally generated operation command signal and the test input signal; and
a pull-down resistor connected between an input terminal of the test input unit receiving the test input signal and a ground terminal.

18. The RFID tag according to claim 17, wherein the test input unit activates and outputs the command signal when either the operation command signal or the test input signal is activated.

19. The RFID tag according to claim 17, wherein the test input unit outputs the command signal such that the command signal corresponds to the operation command signal when in a normal operation mode, and wherein the test input unit outputs the command signal such that the command signal corresponds to the test input signal when in the test operation mode.

20. The RFID tag according to claim 14, wherein the test output driving unit comprises a MOS transistor having an open drain structure.

21. The RFID tag according to claim 20, wherein the MOS transistor is an NMOS transistor connected between the output of the test output signal and a ground terminal, and the NMOS transistor has a gate receiving the response signal.

22. The RFID tag according to claim 13, wherein the memory block includes a plurality of nonvolatile ferroelectric capacitors.

23. A RFID tag comprising:
a power voltage input means configured to receive a power voltage;
a test signal input means configured to receive a test input signal; and
a test signal output means configured to output a test output signal corresponding to the test input signal.

24. The RFID tag according to claim 23, further comprising a test signal generating means configured to generate the test output signal in response to the test input signal.

25. The RFID tag according to claim 24, further comprising a buffer means configured to apply the test input signal to the test signal generating means when in a test operation mode.
